(19) United States
(12) Patent Application Publication
(10) Pub. No.: US 2022/0056244 A1
(43) Pub. Date: Feb. 24, 2022

(54) RUBBER REINFORCEMENT ADHESIVE

(71) Applicant: The Goodyear Tire & Rubber Company, Akron, OH (US)

(72) Inventor: James Gregory Gillick, Akron, OH (US)

(21) Appl. No.: 16/995,863

(22) Filed: Aug. 18, 2020

(51) Int. Cl. C08L 9/06; C09J 125/18; C09J 4/06; C08L 67/03; B60C 1/00

(52) U.S. Cl. CPC C08L 9/06; C09J 125/18; C09J 4/06; B60C 2001/0066; B60C 1/0041; C08L 2205/16; B60C 2001/005; C08L 67/03

(57) ABSTRACT

A rubber reinforcement adhesive comprising water and the reaction product of phloroglucinol and tris(hydroxymethyl)nitromethane.

### BACKGROUND

The use of resorcinol and formaldehyde in tire cord fiber adhesives has come under increasing scrutiny in recent years due to regulatory concerns. Recently several different technologies have been proposed to eliminate the use of aqueous formaldehyde, resorcinol, and resorcinol/formaldehyde preformed resins for tire cord adhesives. See for example Gomes et al., “Adhesion Activation of Tire Textiles by Resorcinol Formaldehyde Free Coatings”, Rubberworld.com, March 2016 pp 24-26.

### SUMMARY

The present invention is directed to a rubber reinforcement adhesive comprising phloroglucinol and tris(hydroxymethyl)nitromethane, a polymer cord reinforced rubber composition wherein the polymer cords are treated with the adhesive, and a tire comprising the polymer cord reinforced rubber composition. The invention is further directed to a method of making a pneumatic tire.

### DESCRIPTION

There is disclosed a rubber reinforcement adhesive comprising phloroglucinol and tris(hydroxymethyl)nitromethane, a polymer cord reinforced rubber composition wherein the polymer cords are treated with the adhesive, a tire comprising the polymer cord reinforced rubber composition, and a method of making the tire.

In one embodiment, the adhesive includes the reaction product of phloroglucinol and tris(hydroxymethyl)nitromethane, otherwise referred to herein as a phloroglucinol-tris(hydroxymethyl)nitromethane resin.

In one embodiment, the adhesive may include the phloroglucinol-tris(hydroxymethyl)nitromethane resin, a styrene-butadiene copolymer latex, and a vinylpyridine-styrene-butadiene terpolymer latex.

In one embodiment, the adhesive may include the phloroglucinol-tris(hydroxymethyl)nitromethane resin, a styrene-butadiene copolymer latex, a vinylpyridine-styrene-butadiene terpolymer latex, and a blocked isocyanate.

The phloroglucinol may be dissolved in water to which tris(hydroxymethyl)nitromethane has been added together with a strong base such as sodium hydroxide. The strong base should generally constitute an amount sufficient to fully dissolve the phloroglucinol, and the molar ratio of the tris(hydroxymethyl)nitromethane to phloroglucinol should be in a range of from about 0.5 to about 1.5. The aqueous solution of the resole or condensation product or resin is mixed with the styrene-butadiene latex and vinylpyridine-styrene-butadiene terpolymer latex. The phloroglucinol-tris(hydroxymethyl)nitromethane reaction product should constitute from 5 to 40 parts and preferably around 10 to 28 parts by solids of the latex mixture. The phloroglucinol-tris(hydroxymethyl)nitromethane reaction product should preferably be partially reacted or reacted so as to be soluble in water. Sufficient water is then preferably added to give around 12 percent to 28 percent by weight overall solids in the final dip. The weight ratio of the polymeric solids from the latex to the phloroglucinol-tris(hydroxymethyl)nitromethane resin should be in a range of about 2 to about 6.

The adhesive may include a blocked isocyanate. In one embodiment from about 1 to about 8 parts by weight of solids of blocked isocyanate is added to the adhesive. The blocked isocyanate may be any suitable blocked isocyanate known to be used in adhesive dips including, but not limited to, caprolactam blocked methylene-bis-(4-phenylisocyanate), such as Grilbond-IL6 available from EMS American Grilon, Inc., and phenol formaldehyde blocked isocyanates as disclosed in U.S. Pat. Nos. 3,226,276; 3,268,467; and 3,298,984; the three of which are fully incorporated herein by reference. As a blocked isocyanate, use may be made of reaction products between one or more isocyanates and one or more kinds of isocyanate blocking agents. The isocyanates include monoisocyanates such as phenyl isocyanate, dichlorophenyl isocyanate and naphthalene monoisocyanate, diisocyanate such as tolylene diisocyanate, dianisidine diisocyanate, hexamethylene diisocyanate, m-phenylene diisocyanate, tetramethylene diisocyante, alkylbenzene diisocyanate, m-xylene diisocyanate, cyclohexylmethane diisocyanate, 3,3-dimethoxyphenylmethane-4,4′-diisocyanate, 1-alkoxybenzene-2,4-diisocyanate, ethylene diisocyanate, propylene diisocyanate, cyclohexylene-1,2-diisocyanate, diphenylene diisocyanate, butylene-1,2-diisocyanate, diphenylmethane-4,4diisocyanate, diphenylethane diisocyanate, 1,5-naphthalene diisocyanate, etc., and triisocyanates such as triphenylmethane triisocyanate, diphenylmethane triisocyanate, etc. The isocyanate-blocking agents include phenols such as phenol, cresol, and resorcinol, tertiary alcohols such as t-butanol and t-pentanol, aromatic amines such as diphenylamine, diphenylnaphthylamine and xylidine, ethyleneimines such as ethylene imine and propyleneimine, imides such as succinic acid imide, and phthalimide, lactams such as ε-caprolactam, δ-valerolactam, and butyrolactam, ureas such as urea and diethylene urea, oximes such as acetoxime, cyclohexanoxime, benzophenon oxime, and α-pyrolidon.

The polymers may be added in the form of a latex or otherwise. In one embodiment, a vinylpyridine-styrene-butadiene terpolymer latex and styrene-butadiene rubber latex may be added to the adhesive. The vinylpyridine-styrene-butadiene terpolymer may be present in the adhesive such that the solids weight of the vinylpyridine-styrene-butadiene terpolymer is from about 50 percent to about 100 percent of the solids weight of the styrene-butadiene rubber; in other words, the weight ratio of vinylpyridine-styrene-butadiene terpolymer to styrene-butadiene rubber is from about 1:2 to about 2:1.

The adhesive may be used to treat a rubber reinforcement cord, otherwise known herein as a treated polymer cord.

The term “cord” means one or more of a reinforcing element, formed by one or more polymer filaments which may or may not be twisted or otherwise formed. Therefore, cords using the present invention may comprise from one (monofilament) to multiple filaments. Suitable cords are made from polymeric materials including rayon, nylon (polyamide), polyesters such as polyethylene terephthalate (PET), aramid, and hybrid cords formed from combinations of such yarns.

In one embodiment, the treatment of the polymer cord comprises treating the polymer cord with the adhesive comprising phloroglucinol-tris(hydroxymethyl)nitromethane resin and one or more elastomer latexes.

In a treatment step, the polymer cord is dipped in the adhesive. In one embodiment, the adhesive composition is comprised of (1)phloroglucinol, (2) tris(hydroxymethyl)nitromethane and (3) a styrene-butadiene (SBR) rubber latex, (4) a vinylpyridine-styrene-butadiene (PSBR) terpolymer latex, and optionally (5) a blocked isocyanate. The phloroglucinol reacts with tris(hydroxymethyl)nitromethane to produce a phloroglucinol-tris(hydroxymethyl)nitromethane reaction product.

The cord treated with the adhesive may be used as a reinforcement in a cord-reinforced rubber composition. In such a cord-reinforced rubber composition, the treated polymer reinforcement cord directly contacts a rubber composition. In this form, the treated polymer reinforcement cord includes the adhesive treatment dispersed on the surface of the cord by dipping the cord into the adhesive followed by drying, wherein the adhesive treatment includes the reaction product of phloroglucinol and tris(hydroxymethyl)nitromethane and any other solids from the adhesive, minus the water that has been removed by oven drying or other means.

The cord-reinforced rubber composition may be used in a belt structure, bead or carcass of a tire. “Belt structure” means at least two layers of plies of parallel cords, underlying the tread, unanchored to the bead and having both left and right cord angles in the range from about 17 to about 27 degrees with respect to the equatorial plane (EP) of the tire. “Carcass” means the tire structure apart from the belt structure, the tread and the undertread but including the beads. The carcass ply includes reinforcing cords embedded in an elastomeric substance and that these components are considered to be a single entry. “Bead” means that part of the tire comprising an annular tensile member wrapped by the carcass ply and shaped, with or without other reinforcement elements such as flippers, chippers, apexes, toe guards, and chafers, to fit the design rim.

It is readily understood by those having skill in the art that the rubber compositions used in tire components would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing materials such as, for example, carbon black and/or silica. As known to those skilled in the art, depending on the intended use of the sulfur vulcanizable and sulfur vulcanized material (rubbers), the additives mentioned above are selected and commonly used in conventional amounts.

The rubber composition may contain various conventional rubber additives. Typical additions of carbon black comprise about 10 to 150 parts by weight of diene rubber (phr).

A number of commercially available carbon blacks may be used. Included in the list of carbon blacks are those known under the ASTM designations N299, S315, N326, N330, M332, N339, N343, N347, N351, N358, N375, N539, N550 and N582. Such processing aids may be present and can include, for example, aromatic, naphthenic, and/or paraffinic processing oils. Typical amounts of tackifying resins, such as phenolic tackifiers, range from 1 to 3 phr. Silica, if used, may be used in an amount of about 10 to about 150 phr, often with a silica coupling agent. Representative silicas may be, for example, hydrated amorphous silicas. Typical amounts of antioxidants comprise about 1 to about 5 phr. Representative antioxidants may be, for example, diphenyl-p-phenylenediamine, polymerized 1,2 dihydro 2,2,4 trimethylquinoline and others, such as, for example, those disclosed in the Vanderbilt Rubber Handbook (1990), Pages 343 through 362. Typical amounts of antiozonants comprise about 1 to about 5 phr. Representative antiozonants may be, for example, those disclosed in the Vanderbilt Rubber Handbook (1990), Pages 363 through 367. Typical amounts of fatty acids, if used, which can include stearic acid comprise about 0.5 to about 3 phr. Typical amounts of tin oxide comprise about 2 to about 10 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur vulcanizing agent is elemental sulfur. As known to those skilled in the art, sulfur vulcanizing agents are used in an amount ranging from about 0.5 to about 5 phr, or even, in some circumstances, up to about 8 phr, with a range of from about 3 to about 5 being preferred.

Accelerators are used to control the time and/or temperature required for vulcanization and to improve the properties of the vulcanizate. In one embodiment, a single accelerator system may be used, i.e., primary accelerator. Conventionally, a primary accelerator is used in amounts ranging from about 0.5 to about 2.5 phr. In another embodiment, combinations of two or more accelerators which is generally used in the larger amount (0.5 to 2.0 phr), and a secondary accelerator which is generally used in smaller amounts (0.05 to 0.50 phr) in order to activate and to improve the properties of the vulcanizate. Combinations of these accelerators have been known to produce a synergistic effect of the final properties and are somewhat better than those produced by use of either accelerator alone. In addition, delayed action accelerators may be used which are not affected by normal processing temperatures but produce satisfactory cures at ordinary vulcanization temperatures. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The tire can be built, shaped, molded and cured by various methods which will be readily apparent to those having skill in such art. For example, the polymer cord reinforced rubber composition may be produced by calendaring of the cords into a rubber extrudate.

The prepared tire of this invention is conventionally shaped and cured by methods known to those having skill in such art.

The invention is further illustrated by the following non-limiting examples. Examples

The following examples illustrate the production and use of resorcinol-formaldehyde free adhesives as treatments for tire reinforcing cords. Resorcinol alternatives

The following commercially available materials were evaluated as resorcinol alternatives:
Phloroglucinol (1,3,5-trihydroxybenzene)
Morin (2′,3,4′,5,7-Pentahydroxyflavone)
Sesamol (3,4-Methylenedioxyphenol)
Tannic Acid
Formaldehyde alternatives

The following commercially available materials were evaluated as formaldehyde alternatives:
Sodium hydroxymethylsulfinate
Trishydroxymethylnitromethane
Zoldine LH1000 is a commercial product of Angus Chemical likely a bis-oxazolidine modified to be water soluble.
Furfural (furan-2-carboxaldehyde)
Salicylaldehyde (o-hydroxybenzaldehyde)
p-Anisaldehyde (p-methoxybenzaldehyde)
Vanillin (4-hydroxy-3-methoxybenzaldehyde)
p-Nitrobenzaldehyde

### EXAMPLE 1

### Adhesive Preparation

The general approach taken was to replicate as closely as possible the degree of resin crosslinking developed by a formaldehyde to resorcinol molar ratio (1.7) used in a standard RFL adhesive. In some cases, direct replacement of formaldehyde or resorcinol on a molar basis led to unstable adhesives which coagulated during aging because of the significantly higher molecular weights of the alternative components. In those cases, the latex to resin dry weight mass ratio was adjusted to be at least 3.0 (vs 5.7 for standard RFL). The same latex blend (50:50 PSBR:SBR) was used as in the standard RFL. The amount of sodium hydroxide used had to be increased when using phloroglucinol because the solubility of phloroglucinol in water is 100 times less than that of resorcinol. Undissolved phloroglucinol particles in the initial attempt at resin preparation led to immediate coagulation on addition of latex. To prevent this the sodium hydroxide level was increased to a 1:1 molar ratio, which resulted in formation of a clear solution prior to the addition of aldehydes and latex. The same high base content was subsequently used with other formulations as well to ensure complete solution of the resin base.

The standard procedure used for adhesives preparation was to start by dissolving the resorcinol alternative in water. All resorcinol alternatives except for resorcinol required the addition of 10% sodium hydroxide solution to completely to achieve a clear solution. The formaldehyde alternative was then added, and the solution was stirred at room temperature for at least 4 hours prior to latex addition. This delayed latex addition is not normally required for the standard RFL but is commonly used with ammoniated RFL adhesives to ensure reaction of the formaldehyde prior to introduction of ammonia stabilized latex. In these experiments the same delay of latex addition was used for the standard RFL adhesive with no adverse effects on adhesion. Delaying the latex addition also allowed for easier assessment of changes in the resin solution during the initial stages of reaction.

RF resins generally exhibit an intense red color which starts to form almost immediately after combining resorcinol, formaldehyde, and a base such as sodium hydroxide. The initial color has been ascribed to formation of an ortho-quinone methide intermediate, but the color in the later stages has been identified as deriving from subsequent oxidation products including p-quinones (see T L Huber et al, “Chemical Derivation to Enhance the Chemical/Oxidative Stability of Resorcinol-Formaldehyde (R-F) Resin”, Report to the US Department of Energy under Contract DE-AC05-76-RLO 1830, September 1996.) The formation of a red color thus provides a qualitative indicator of reaction.

Formulations evaluated are shown in Tables I-III. The amounts listed are the dry weight proportions of the adhesives, which were all formulated to 18% solids in water for use in cord dipping. Values were rounded to one decimal place to reflect the precision of the scale used in preparing the adhesives. Note that in some cases multiple formulations for the same components are shown with different proportions. This was to address issues found in initial adhesive preparation or the explore on a limited basis the effect of changing proportions. Comments about the physical appearance of the adhesive during and after aging are included where appropriate. Unless otherwise noted all adhesives developed a reddish-brown color to some degree during 24-hour adhesive aging.

TABLE I
Resorcinol Replacements

| | RFL | Phloroglucinol | Phloroglucinol | Tannic | Tannic Acid + | | |
|---|---|---|---|---|---|---|---|
| Ingredient | Control | 1^{st} Version * | 2^{nd} Version | Acid | Phloroglucinol | Morin | Sesamol |
| Resorcinol | 9.4 | | | | | | |
| Phloroglucinol | | 10.8 | 10.4 | | 1.1 | | |
| Tannic Acid | | | | 14.5 | 13.1 | | |
| Morin | | | | | | 12.2 | |
| Sesamol | | | | | | | 11.2 |
| Sodium | 1.1 | 1.1 | 3.3 | 1.1 | 1.1 | 3.2 | 3.2 |
| Hydroxide | | | | | | | |
| Formaldehyde | 4.4 | 4.4 | 4.3 | 4.4 | 4.4 | 4.2 | 4.2 |
| PSBR | 42.5 | 42.5 | 41.0 | 40.0 | 40.0 | 40.2 | 40.6 |
| SBR | 42.5 | 42.5 | 41.0 | 40.0 | 40.0 | 40.2 | 40.6 |
| Latex/Resin | 5.7 | 5.2 | 4.6 | 4.0 | 4.1 | 4.1 | 4.3 |
| Ratio | | | | | | | |
| Donor/Acceptor | 1.7 | 1.7 | 1.7 | 1.7 | 1.7 | 1.7 | 1.7 |
| Molar Ratio | | | | | | | |
| NaOH/Acceptor | 0.3 | 0.3 | 1.0 | 0.3 | 0.3 | 1.0 | 1.0 |
| Molar Ratio | | | | | | | |

* Phloroglucinol did not fully dissolve and latex coagulated on addition to resin mixture

TABLE II
Formaldehyde Replacements

| | | | Tris | Tris | Tris | |
|---|---|---|---|---|---|---|
| | | Sodium | (hydroxymethyl) | (hydroxymethyl) | (hydroxymethyl) | |
| | RFL | Hydroxymethyl | nitromethane | nitromethane | nitromethane | |
| Ingredient | Control | Sulfinate * | 1^{st} Version | 2^{nd} Version | Phloroglucinol | LH1000 |
| Resorcinol | 9.4 | 8.1 | 9.1 | 8.3 | | 6.7 |
| Phloroglucinol | | | | | 9.5 | |
| Sodium | | 17.2 | | | | |
| Hydroxymethyl | | | | | | |
| Sulfinate | | | | | | |
| Tris(hydroxymethyl) | | | 7.2 | 14.5 | 12.1 | |
| nitromethane | | | | | | |
| LH1000 | | | | | | 15.3 |
| Sodium Hydroxide | 1.1 | 0.98 | 1.1 | 3.0 | 3. | 2.3 |
| Formaldehyde | 4.4 | | | | | |
| PSBR | 42.5 | 36.8 | 41.3 | 37.7 | 37.7 | 37.8 |
| SBR | 42.5 | 36.8 | 41.3 | 37.7 | 37.7 | 37.8 |
| Latex/Resin Ratio | 5.7 | 2.8 | 4.7 | 3.1 | 3.1 | 3.1 |
| Donor/Acceptor | 1.7 | 1.7 | 0.6 | 1.3 | 1.1 | 1.0 |
| Molar Ratio | | | | | | |
| NaOH/Acceptor | 0.3 | 0.3 | 0.3 | 1.0 | 1.0 | 1.0 |
| Molar Ratio | | | | | | |

* Adhesive showed no color formation during resin aging and developed an opaque white appearance after latex addition

TABLE III
Alternative Aldehydes

| | | | Vanillin | Vanillin | Vanillin | | |
|---|---|---|---|---|---|---|---|
| | | | 1^{st} | 2^{nd} | 3^{rd} | p- | p- |
| Ingredient | Furfural | Salicylaldehyde * | Version ** | Version *** | Version | Nitrobenzaldehyde | Anisaldehyde |
| Resorcinol | 8.6 | 8.3 | 8.0 | 7.8 | 4.0 | 5.3 | 5.4 |
| Sodium Hydroxide | 1.0 | 1.0 | | 2.8 | 1.4 | 1.9 | 2.0 |
| Furfural | 13.0 | | | | | | |
| Salicylaldehyde | | 15.9 | | | | | |
| Vanillin | | | 19.0 | 18.7 | 9.5 | | |
| p- | | | | | | 12.7 | |
| Nitrobenzaldehyde | | | | | | | |
| p-Anisaldehyde | | | | | | | 11.3 |
| PSBR | 38.7 | 37.4 | 36.0 | 35.3 | 42.5 | 40.0 | 40.6 |
| SBR | 38.7 | 37.4 | 36.0 | 35.3 | 42.5 | 40.0 | 40.6 |
| Latex/Resin Ratio | 3.4 | 3.0 | 2.6 | 2.4 | 5.7 | 4.0 | 4.4 |
| Donor/Acceptor | 1.7 | 1.7 | 1.7 | 1.7 | 1.7 | 1.7 | 1.7 |
| Molar Ratio | | | | | | | |
| NaOH/Acceptor | 0.3 | 0.3 | 0.3 | 1.0 | 1.0 | 1.0 | 1.0 |
| Molar Ratio | | | | | | | |

* Separate phase formed but adhesive remained stable with stirring
** Vanillin did not completely dissolve, and adhesive coagulated after latex addition
*** Vanillin dissolved but adhesive coagulated during aging after latex addition

### EXAMPLE 2

Three cords were chosen to conduct adhesive screening: 1840/1/2 rayon, 1400/1/2 nylon 6,6, and 1670/1/2 PET. Standard process conditions were used as shown for reference purposes in Table IV. No attempt was made to optimize the processes for adhesive changes.

TABLE IV
Cord Process Conditions

| | Rayon | Nylon | PET |
|---|---|---|---|
| Dip 1 | RFL¹, 18% Solids | RFL¹, 18% Solids | Subcoat² |
| Oven 1, F | 360 | 280 | 280 |
| Oven 2, F | 360 | 410 | 480 |
| 1^{st} Zone | 1.0 | 2.1 | 3.0 |
| Tension, lbs | | | |
| Dip 2 | None | None | RFL¹, 18% Solids |
| Oven 3, F | 360 | 280 | 280 |
| Oven 4, F | 360 | 450 | 480 |
| 2^{nd} Zone | 1.0 | 4.0 | 1.0 |
| Tension, lbs | | | |
| Exposure Time | 60 secs in | 60 secs in | 60 secs in |
| | each oven | each oven | each oven |

¹RFL control RFL from Tables I & II
²A combination of epoxy/blocked isocyanate resins in water similar to that disclosed in U.S. Pat. No. 3,307,966

Adhesion results are tabulated in Tables V-VII. A wide range of adhesion forces and coverage were found, and in some cases different levels of performance were seen for the same adhesives with different fibers. This could either reflect differences in fiber/adhesive interaction or differences in the response of the adhesive to process conditions, which vary based on material type. Strip adhesion samples that exhibited pull-through due to extremely low adhesion are marked as “Failed”.

TABLE V
Hot U Adhesion¹ to Standard Reference Compound²

| | Rayon | Nylon | PET Pullout |
|---|---|---|---|
| | Pullout | Pullout | Force, |
| | Relative | Relative | Relative |
| Adhesive | Force | Force | Force |
| Control RFL | 100 | 100 | 100 |
| Phloroglucinol 2^{nd} Version | 104 | 95 | 105 |
| Tannic Acid | 33 | 26 | 71 |
| Tannic Acid/Phloroglucinol | 53 | 35 | 105 |
| Morin | 97 | 91 | 100 |
| Sesamol | 24 | 21 | 27 |
| Sodium Hydroxymethyl | 46 | 30 | 44 |
| Sulfinate | | | |
| Tris (Hydroxymethyl) | 87 | 83 | 115 |
| nitromethane 1^{st} Version | | | |
| Tris (Hydroxymethyl) | 89 | 85 | 91 |
| nitromethane 2^{nd} Version | | | |
| Tris (Hydroxymethyl) | 111 | 121 | 102 |
| nitromethane/Phloroglucinol | | | |
| LH1000 1 Day Aged | 96 | 43 | 39 |
| LH1000 5 Day Aged | 108 | 44 | 35 |
| LH1000 11 Day Aged | 109 | 44 | 45 |
| Furfural | 100 | 91 | 104 |
| Salicylaldehyde | 46 | 41 | 94 |
| Vanillin 3^{rd} Version | 61 | 31 | 58 |
| p-Nitrobenzaldehyde | 56 | 68 | 94 |
| p-Anisaldehyde | 31 | 30 | 70 |

¹Hot U Adhesion determined by ASTM D4777-88
²Goodyear reference compound used for fabric release testing

TABLE VI
Rayon Strip Adhesion¹ to Standard
Carcass Ply Rubber Compounds²

| | Plycoat 1 | Plycoat 2 | Plycoat 3 |
|---|---|---|---|
| | Relative | Relative | Relative |
| | Force/ | Force/ | Force/ |
| | RC rating | RC rating | RC rating |
| Adhesive | (0-5 scale) | (0-5 scale) | (0-5 scale) |
| Control RFL | 100/4.5 | 100/4 | 100/2 |
| Phloroglucinol 2^{nd} Version | 75/3 | 70/3 | 81/1 |
| Tannic Acid | 36/0 | | |
| Tannic Acid/Phloroglucinol | 34/0 | | 70/0 |
| Morin | 82/3.5 | 71/3 | 91/2.5 |
| Sesamol | 44/0 | Failed | Failed |
| Sodium Hydroxymethyl | 24/0 | 50/0 | |
| Sulfinate | | | |
| Tris (Hydroxymethyl) | 49/1 | | |
| nitromethane 1^{st} Version | | | |
| Tris (Hydroxymethyl) | 94/5 | 86/4 | 110/3 |
| nitromethane 2^{nd} Version | | | |
| Tris (Hydroxymethyl) | 84/5 | 96/4.5 | 100/2.5 |
| nitromethane/Phloroglucinol | | | |
| LH1000 1 Day Aged | 70/2 | 77/1 | 84/1 |
| LH1000 5 Day Aged | 69/3 | 72/1 | 81/1 |
| LH1000 11 Day Aged | 67/4 | 75/1 | 80/1 |
| Furfural | 70/3 | 69/2 | |
| Salicylaldehyde | 59/2 | 66/1 | |
| Vanillin 3^{rd} Version | 32/0 | 52/0 | 73/0 |
| p-Nitrobenzaldehyde | 37/0 | 53/0 | 58/0 |
| p-Anisaldehyde | 39/0 | 78/0 | 100/2.5 |

¹Strip adhesion determined by a variation of ASTM D4393 Strap Peel Adhesion Test
²Standard rubber ply compounds: Plycoat 1 and 2 are standard passenger plycoats, Plycoat 3 is the same reference compound used for Hot U testing in Table V

TABLE VII
Nylon Strip Adhesion to Standard
Carcass Ply Rubber Compounds¹

| | Plycoat 4 | Plycoat 5 | Plycoat 6 | Plycoat 3 |
|---|---|---|---|---|
| | Relative | Relative | Relative | Relative |
| | Force/ | Force/ | Force/ | Force/ |
| | RC rating | RC rating | RC rating | RC Rating |
| Adhesive | (0-5 scale) | (0-5 scale) | (0-5 scale) | (0-5 Scale) |
| Control RFL | 100/5 | 100/3 | 100/4 | 100/4.5 |
| Phloroglucinol 2^{nd} | 74/4.5 | 64/0 | 88/1 | 76/2.5 |
| Version | | | | |
| Tannic Acid | 19/0 | 74/0 | 35/0 | |
| Tannic Acid/ | 19/0 | Failed | 52/0 | |
| Phloroglucinol | | | | |
| Morin | 76/3.5 | 54/0 | 77/1 | 76/2.5 |
| Sesamol | 25/0 | Failed | Failed | 38/0 |
| Sodium Hydroxymeth- | 25/0 | 86/0 | 55/0 | |
| yl Sulfinate | | | | |
| Tris (Hydroxymethyl) | 66/2 | 58/0 | 50/0 | |
| nitromethane 1^{st} | | | | |
| Version | | | | |
| Tris (Hydroxymethyl) | 67/3 | 58/0 | 81/2 | 64/1 |
| nitromethane 2^{nd} | | | | |
| Version | | | | |
| Tris (Hydroxymethyl) | 95/5 | 92/3 | 113/3 | 91/3 |
| nitromethane/ | | | | |
| Phloroglucinol | | | | |
| LH1000 1 Day Aged | 50/1 | Failed | 49/0 | 53/0 |
| LH1000 5 Day Aged | 45/1 | Failed | 42/0 | 58/0 |
| LH1000 11 Day Aged | 46/1 | Failed | 44/0 | 62/0 |
| Furfural | 103/5 | 76/1 | 87/3 | |
| 62Salicylaldehyde | 34/0 | 64/0 | 29/0 | |
| Vanillin 3^{rd} | 23/0 | 92/0 | 51/0 | 36/0 |
| Version | | | | |
| p-Nitrobenzaldehyde | 43/1 | 62/0 | 58/0 | 35/0 |
| p-Anisaldehyde | 25/0 | 68/0 | 53/0 | 40/0 |

¹Standard rubber ply compounds: Plycoat 4 is a standard passenger compound, plycoat 5 is a bias aircraft tire plycoat, and plycoat 6 is a standard race tire plycoat. Plycoat 3 as in Table VI.

TABLE VIII
PET 120 C Strip Adhesion to Standard
Carcass Plycoat Rubber Compounds¹

| | Plycoat 1 | Plycoat 2 | Plycoat 3 |
|---|---|---|---|
| | Relative | Relative | Relative |
| | Force/ | Force/ | Force/ |
| | RC rating | RC rating | RC rating |
| Adhesive | (0-5 scale) | (0-5 scale) | (0-5 scale) |
| Control RF | 100/4.5 | 100/5 | 100/3 |
| Phloroglucinol 2^{nd} Version | 98/4.5 | 114/5 | 108/3 |
| Tannic Acid | 43/0 | 67/1 | |
| Tannic Acid/Phloroglucinol | 77/4 | 88/4 | |
| Morin | 88/4.5 | 110/4.5 | 106/3 |
| Sesamol | 30/0 | 55/0 | 45/0 |
| Sodium Hydroxymethyl | 41/0 | 64/0 | |
| Sulfinate | | | |
| Tris (Hydroxymethyl) | 85/4 | 95/4 | |
| nitromethane 1^{st} Version | | | |
| Tris (Hydroxymethyl) | 91/4.5 | 77/4.5 | 100/3 |
| nitromethane 2^{nd} Version | | | |
| Tris (Hydroxymethyl) | 96/5 | 110/5 | 102/5 |
| nitromethane/Phloroglucinol | | | |
| LH1000 1 Day Aged | 35/0 | 99/2 | 104/0 |
| LH1000 5 Day Aged | 60/1 | 106/3 | 98/0 |
| LH1000 11 Day Aged | 76/2 | 106/4 | 85/0 |
| Furfural | 94/4.5 | 108/5 | |
| Salicylaldehyde | 85/3.5 | 99/4 | |
| Vanillin 3^{rd} Version | 30/0 | 68/0 | 68/0 |
| p-Nitrobenzaldehyde | 84/4 | 108/4.5 | 116/4 |
| n-Anisaldehyde | 33/0 | 63/0 | 56/0 |

¹Plycoats 1-3 as in Table VI.

More compositions matched controls in adhesion to PET than to rayon or nylon. One possible explanation is that for PET the subcoat provides the bonding to the fiber whereas in rayon and nylon the phenolic resin system (RFL or replacement) is the primary component for fiber bonding. Another possibility is that some of the resin systems may not crosslink sufficiently during room temperature aging and require higher treating temperatures during cord dipping to complete resin formation. PET has the highest process temperature of three cord types tested and so might provide the greatest possibility of further reaction during dipping.

Coat compounds were also found to have different results with PET cord. Many more formulations showed good results in plycoat 2 than in plycoat 1 or plycoat 3.

Adhesive aging time was only evaluated in the case of LH1000, which exhibited a pronounced increase in color as the adhesive was stored at room temperature. No change was found for rayon or nylon dipped cords, but the aged adhesive showed increases in either peel force or coverage for PET cords in plycoat 1 and plycoat 2 compounds. This indicates that there is potential for improved results from extended or higher temperature aging in some cases.

Phloroglucinol and tris(hydroxymethyl)nitromethane, which showed best results overall as individual replacements for resorcinol and formaldehyde, were then combined and assessed in the same fashion. Adhesion equal to or better than controls was found for fiber/compound combinations. It was observed that the combination of phloroglucinol and tris(hydroxymethyl)nitromethane gave better results overall than either phloroglucinol/formaldehyde or resorcinol/tris(hydroxymethyl)nitromethane adhesives. One possible explanation is that the higher potential reactivity of phloroglucinol changes the kinetics of resin formation such that the phloroglucinol/tris(hydroxymethyl)nitromethane is a closer match to the resorcinol/formaldehyde system.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A rubber reinforcement adhesive comprising water and the reaction product of phloroglucinol and tris(hydroxymethyl)nitromethane.

2. The rubber reinforcement adhesive of claim 1, further comprising at least one rubber selected from styrene-butadiene rubber and vinylpyridine-styrene-butadiene rubber.

3. The rubber reinforcement adhesive of claim 1, wherein the molar ratio of tris(hydroxymethyl)nitromethane to phloroglucinol ranges from 0.5 to 1.5.

4. The rubber reinforcement adhesive of claim 1, wherein the reaction product of phloroglucinol and tris(hydroxymethyl)nitromethane comprises from 5 to 40 parts by weight of the total solid weight in the adhesive.

5. The rubber reinforcement adhesive of claim 1, wherein the reaction product of phloroglucinol and tris(hydroxymethyl)nitromethane comprises from 10 to 28 parts by weight of the total solid weight in the adhesive.

6. The rubber reinforcement adhesive of claim 2, wherein the weight ratio of styrene-butadiene rubber to vinylpyridine-styrene-butadiene rubber ranges from 1:2 to 2:1.

7. A reinforced rubber composition comprising a polymer reinforcement cord directly contacting a rubber composition, the polymer reinforcement comprising an adhesive treatment dispersed on the surface thereof comprising the reaction product of phloroglucinol and tris(hydroxymethyl)nitromethane.

8. The reinforced rubber composition of claim 7, wherein the polymer reinforcement cord is selected from rayon cords, nylon cords, polyester cords, aramid cords, and hybrid cords prepared from combinations of different yarns.

9. The reinforced rubber composition of claim 7, wherein the polymer reinforcement cord is a polyethylene terephthalate cord.

10. The reinforced rubber composition of claim 7, wherein the adhesive treatment further comprises at least one rubber selected from styrene-butadiene rubber and vinylpyridine-styrene-butadiene rubber.

11. The reinforced rubber composition of claim 7, wherein the molar ratio of tris(hydroxymethyl)nitromethane to phloroglucinol ranges from 0.5 to 1.5.

12. The reinforced rubber composition of claim 7, wherein the reaction product of phloroglucinol and tris(hydroxymethyl)nitromethane comprises from 5 to 40 parts by weight of the adhesive treatment.

13. The reinforced rubber composition of claim 7, wherein the reaction product of phloroglucinol and tris(hydroxymethyl)nitromethane comprises from 10 to 28 parts by weight of the adhesive treatment.

14. The reinforced rubber composition of claim 10, wherein the weight ratio of styrene-butadiene rubber to vinylpyridine-styrene-butadiene rubber ranges from 1:2 to 2:1.

15. A pneumatic tire comprising the reinforced rubber composition of claim 7.

16. A method of making a pneumatic tire, comprising the step of treating a polymer reinforcement cord with a rubber reinforcement adhesive comprising water and the reaction product of phloroglucinol and tris(hydroxymethyl)nitromethane to produce a treated reinforcement cord, and contacting the treated reinforcement cord with a rubber composition.

17. The method of claim 16, wherein the polymer reinforcement cord is selected from rayon cords, nylon cords, polyester cords, aramid cords, and hybrid cords formed from combinations of different yarns.

18. The method of claim 16, wherein the adhesive treatment further comprises at least one rubber selected from styrene-butadiene rubber and vinylpyridine-styrene-butadiene rubber, wherein the weight ratio of styrene-butadiene rubber to vinylpyridine-styrene-butadiene rubber ranges from 1:2 to 2:1.

19. The method of claim 16, wherein the molar ratio of tris(hydroxymethyl)nitromethane to phloroglucinol ranges from 0.5 to 1.5.

20. The method of claim 16, wherein the reaction product of phloroglucinol and tris(hydroxymethyl)nitromethane comprises from 5 to 40 parts by weight of the total solids in the adhesive.
